(19) United States
(12) Patent Application Publication
(10) Pub. No.: US 2010/0329635 A1
(43) Pub. Date: Dec. 30, 2010

(54) VIDEO REPRODUCING APPARATUS

(76) Inventor: Hiromi Nishiura, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/766,946

(22) Filed: Apr. 26, 2010

(30) Foreign Application Priority Data
Jun. 25, 2009 (JP) 2009-150453

(51) Int. Cl. H04N 5/93; H04N 5/91

(52) U.S. Cl. 386/241; 386/E09.05; 386/E05.003; 386/278; 386/291

(57) ABSTRACT

A video reproducing apparatus for reproducing video data, comprises: a group classify unit for classifying the video data into groups upon a degree of similarity of video characteristic; an importance degree determine unit for determining on whether a video belonging to the group is the video or not, being high in a degree of importance, among those within the group, which are classified by the group classifying unit; a reproduction time setup unit for setting up reproduction time of video for each video, depending on the degree of importance, which is determined by the importance degree determine unit; a unit for holding the degree of importance and the reproduction time that are set up; and a video output unit for outputting the video to a video display unit so that it is displayed in accordance with the reproduction time that is set up, or in the above, further comprises: a reproduction order setup unit, which is configured to set up reproduction order of video for each video, by means of the importance degree determine unit and depending on the video a characteristic quantity; and wherein the video output unit, which is configured to output the video to a video display unit so that it is displayed in accordance with the reproduction order that is set up.

This application relates to and claims priority from Japanese Patent Application No. 2009-150453 filed on Jun. 25, 2009, the entire disclosure of which is incorporated herein by reference.

### BACKGROUND OF THE INVENTION

The present invention relates to a video reproducing apparatus for reproducing/editing video information.

As the background technology in the present technical field is already known the following Patent Document 1. In this Patent Document 1 is disclosed “[Problem(s)] There is provided a video display apparatus for enabling to grasp all contents of the videos by a user, by displaying all of the videos memorized in a data base within a limited reproduction time-period of a slide show. [Means for Dissolution] A video display apparatus 100 comprises: a data base 101 for reserving video data, in relation with meta-information, such as, data of picking up the video, etc., and also a characteristic quantity or volume of video thereof; a grouping portion 102 for dividing the videos into at least one (1) or more groups upon basis of the time distance between respective videos; a group estimation portion 103 for calculating out a group estimation value for each one of the groups divided; a reproduction time-period determining portion 104 for determining a reproduction time-period upon basis of a ratio of the group estimation values in each groups; a display portion 105 for displaying the video upon basis of the reproduction time-period; an input portion 106 for inputting the reproduction time-period of the slide show, etc., into the reproduction time-period determining portion 104; and a display order determining portion 107 for determining an order or sequence of displaying the video, by sorting the videos in a time sequential order.”

### <Prior Art Documents>

### <Patent Documents>

[Patent Document 1] Japanese Patent Laying-Open No. 2007-36737 (2007).

### BRIEF SUMMARY OF THE INVENTION

In recent years, it is possible to take a picture (e.g., a still picture) with using various kinds of equipment, such as, a digital camera/a digital video camera/a mobile phone attached with a camera, etc. There are various recording media, such as, a HDD, a built-in memory and a SD card, etc., for example, and also the capacities thereof are still continuing to increase. With wide spreading of those equipment/recording media, for a user it is possible to take a large amount of still pictures, easily.

The video or picture recorded can be, not only reproduced on a main body of the equipment itself recording it therein, but also reproduced by other equipment, through copying the data within the recording medium into a recording medium of the other equipment, or loading the recording medium onto the other equipment. For example, the video recorded on the SC card with using the digital camera can be reproduced by other equipment, such as, a PC, a TV, a digital photo-frame, etc. And, a function being called “slide show” is also spreading, widely, not reproducing the pictures recorded one by one with an operation of the user, but automatically reproducing a series of pictures, sequentially or at random.

However, since they are mixed up with those to be viewed for a time a little bit longer, and those which may be shown only for a short time, depending on the pictures, sometimes it may be a waste of time for a user, if reducing all the pictures for the same time period with using the slide show function.

Then, a technology is proposed, for example, the picture of single photography is reproduced for a long time, while the picture of series photography for a shot time, determining on whether it is the picture photographed singly or that photographed in series, judging from the time intervals recorded.

There are cases, not only the case that the data is recorded by the user her/himself with using the digital camera, but also the case that the data is recorded with using the camera attached with the mobile phone, or the case of receiving the data, which is recorded by equipment of other person; i.e., there is necessity of managing a large amount of data on the same event. And, there are also the following problems: that a plural number of similar pictures exists, and an order because of the same even, and that when alighting or arranging the pictures, the time sequential order differs from an actual order thereof, because the equipment is different one and the time to be a standard is shifted from. When viewing those with using the slide show function, the user must view a several pieces of similar pictures, and must view them in the order different from the actual sequential order; i.e., it is troublesome and difficult to see.

For dissolving or improving all or a part of the problems mentioned above, according to the present invention, there is provided a video reproducing apparatus, as described in the pending claims attached herewith. For example, in the present video reproducing apparatus, the videos are classified with using a quantity of characteristics of the video. The video classified is analyzed, and reproduction time-period in the slide shown is determined depending on the video.

Also, for example, when classifying them depending on the quantity of video characteristics, time information of the video, which is recorded through the different equipment, is modified or revised.

According to the present invention, the usability is improved of the video reproducing apparatus. For example, it is possible for a user to view only the important video(s) from among a large amount of videos, thereby enabling to select an interesting viewing mode.

Also, for example, since it is possible to exchange a line of videos into a time-sequential order by modifying the time information, it is possible to view the video in the correct order even when executing the slide show reproduction in the time-sequential order, as conventionally.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows the structures of a video reproducing apparatus, according to an embodiment of the present invention;

FIG. 2 shows a reproduction time setup process;

FIG. 3 shows a group classification process;

FIG. 4 shows a group classification process;

FIG. 5 shows a classification upon a time;

FIG. 6 shows a classification upon a composition;

FIG. 7 shows a process for determining a degree of importance;

FIG. 8 shows content and a point thereof to be considered important;

FIG. 9 shows a process for determining the reproduction time/reproduction order;

FIG. 10 shows a reproduction time;

FIG. 11 shows a reproduction order;

FIG. 12 shows information added to the video;

FIG. 13 shows information added to the video;

FIG. 14 shows an operation screen;

FIG. 15 shows selection of display method;

FIG. 16 shows a display screen;

FIG. 17 shows a display screen; and

FIG. 18 shows modification of time information.

### DETAILED DESCRIPTION OF THE PREFERRED EMBODIMENTS

Hereinafter, embodiments according to the present invention will be fully explained by referring to the attached drawings.

### Embodiment 1

Explanation will be made on an example of the preferred embodiment, according to the present invention. However, the present invention should not be limited to the present embodiment.

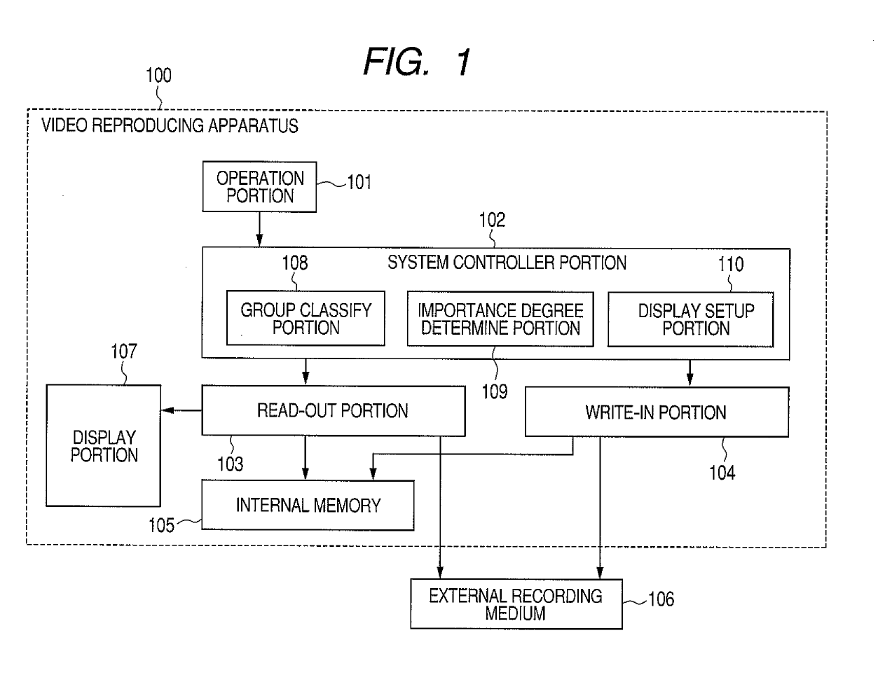

FIG. 1 is a view for showing an example of a reproducing apparatus 100 of the system configuration, according to the present invention.

A reference numeral 101 depicts an operation portion, with which start and/or setup of a slide shown is conducted by a user. A reference numeral 102 depicts a system controller portion, having a group classify portion 108, an importance degree setup portion 109 and a display setup portion 110, etc., and is for controlling an entire. A reference numeral 103 depicts a readout portion, which executes readout of data from an interior memory 105 and/or an external recording medium 106. Also, a reference numeral depicts a write portion, which executes writing of display time information and/or recording time into the interior memory 105 and/or the external recording medium 106. Also, this displays the display time information, which is set up in the system controller portion 102, on a display portion 107.

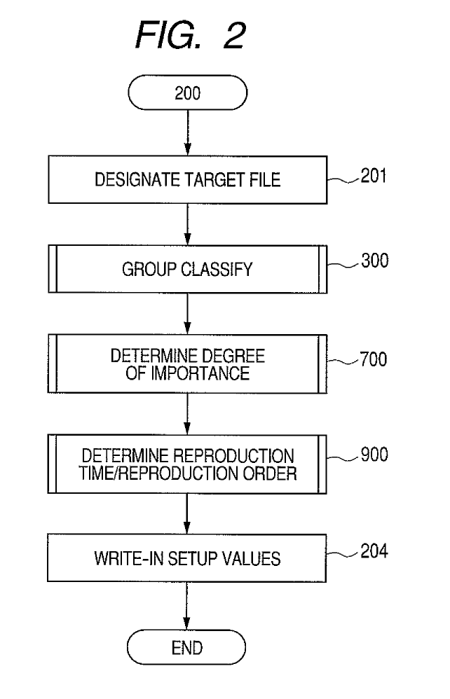

FIG. 2 shows a reproduction time setup flow for a video, within the present embodiment.

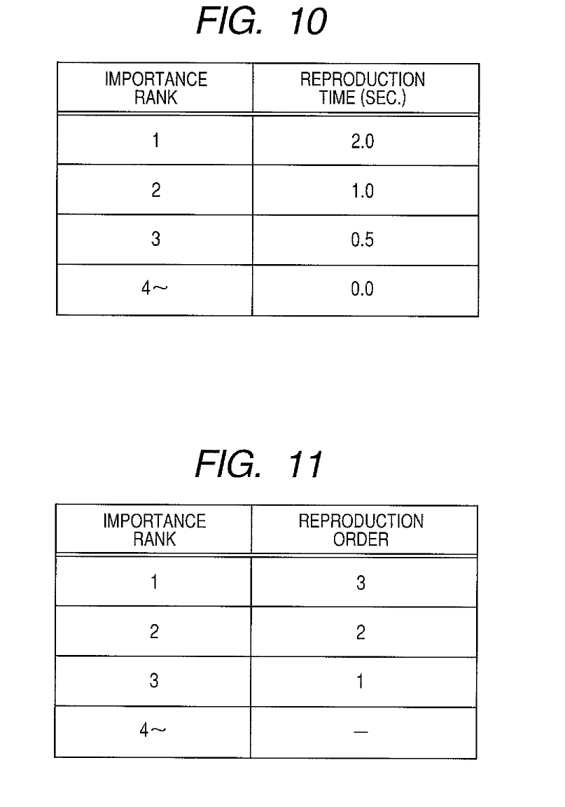

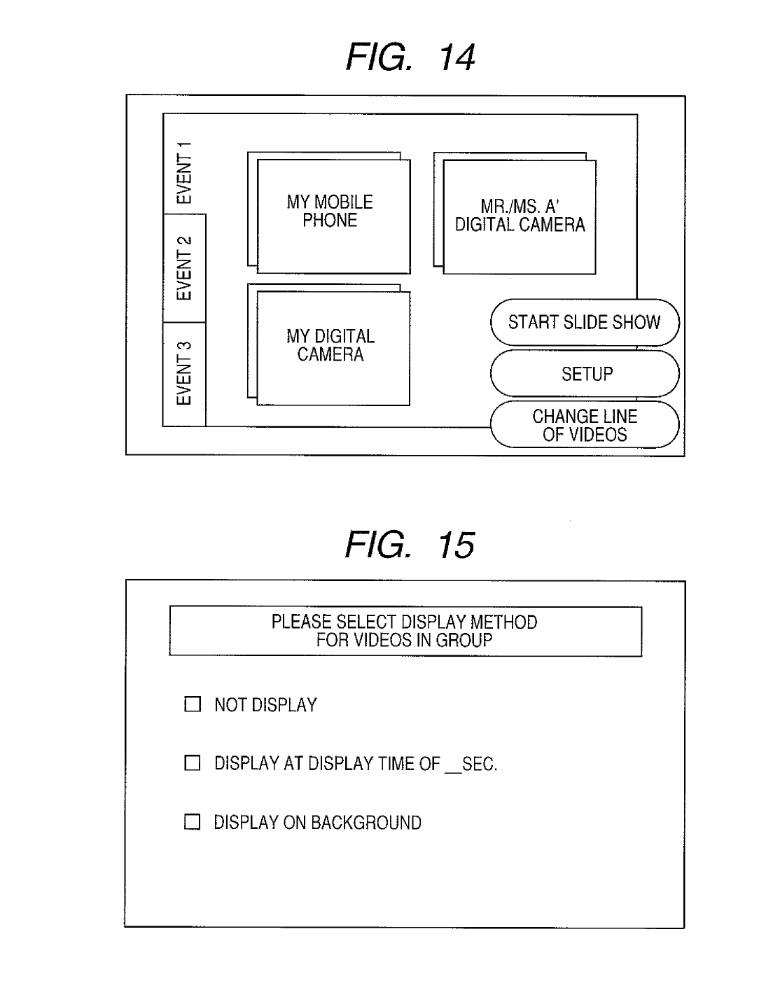

In a step 201, a video group is designated to be an object, upon which a side show reproduction should be executed, within the present embodiment. This may be done by the followings: for example, a method of selecting a plural number of videos through a user operation, a method of selecting a folder including a plural number of videos therein, a method of selecting a plural number of folders, each including a plural number of videos therein, etc. This may be in the form of selecting the folders, such as, “My Mobile Phone”, “My Digital Camera” and/or “Mr./Ms. A's Digital Camera” in an event 1, as an operation screen shown in FIG. 14, for example. Or, it may be a method of no designation made by the user; but in that instance, section may be made on all of the videos recorded in the recording medium, or may be made at random. In a step 300, the videos are classified by a group classify means set up. This group classify means may be set up in advance within the equipment, or may be set up with operation by the user. In a step 700, a degree of importance is determined for all of the videos belonging to the group(s). In a step 900, the reproduction time and the reproduction order are determined for the video. In a step 204, the video addition information shown in FIG. 11 is written into the internal memory or the external recording medium.

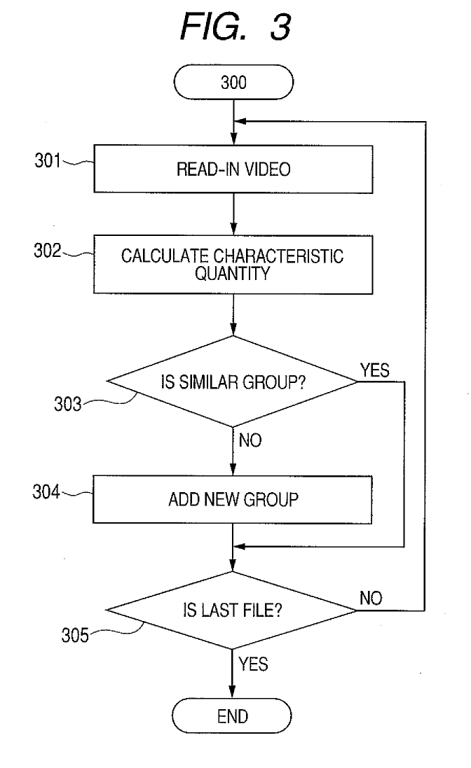

FIG. 3 shows a process flow of group classification, according to the present embodiment.

In a step 301, read-in is made on one (1) piece of video, from the videos designated in the step 201. In a step 302 is calculated out the characteristic quantity depending on the group classify means. In a step 303, classification into a group being high in degree of similarity upon basis of the characteristic quantities calculated in the step 302. If there is no similar group, then the process advances into a step 304. If there is a similar group, the process advances into a step 305. In the step 304 is added a new group. In the step 305 is determined on whether the video classified is the last one to be classified or not. If there is the video not classified yet, then the process advances to the step 301. If it is the last video, the process is finished.

FIG. 4 shows an example of the group classify means in the step 302. When classifying on the time, classification is made with using recoding time as the characteristics. When classifying the video upon a tone of color (i.e., a tint) thereof, it is done with using a histogram of the video. When classifying the pictures upon a person taken therein, the characteristics of the person, or the characteristics of a face taken within the video is used. When classifying the videos upon the composition thereof, it is conducted with using a video patter, such as, an edge characteristic obtained from the video, for example. The method for classification and the characteristics to be used should not be restricted only to those listed up herein. And, it is possible to use only one classifying means or to use a plural number of classifying means in combination therewith.

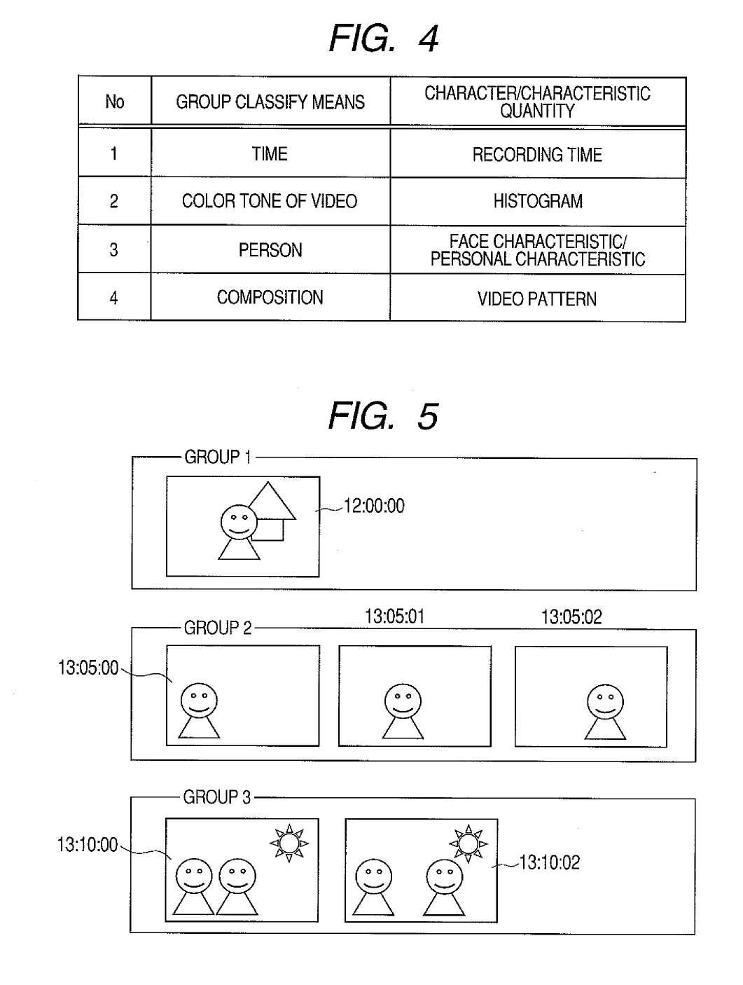

FIG. 5 shows an example of the video, which is classified by the group classifying means upon the time. In a group 1 are recorded the videos at 12:00:00. In a group 2 are recorded the videos at 13:05:00, 13:05:01, and 13:05:02, i.e., by a time interval of 1 second.

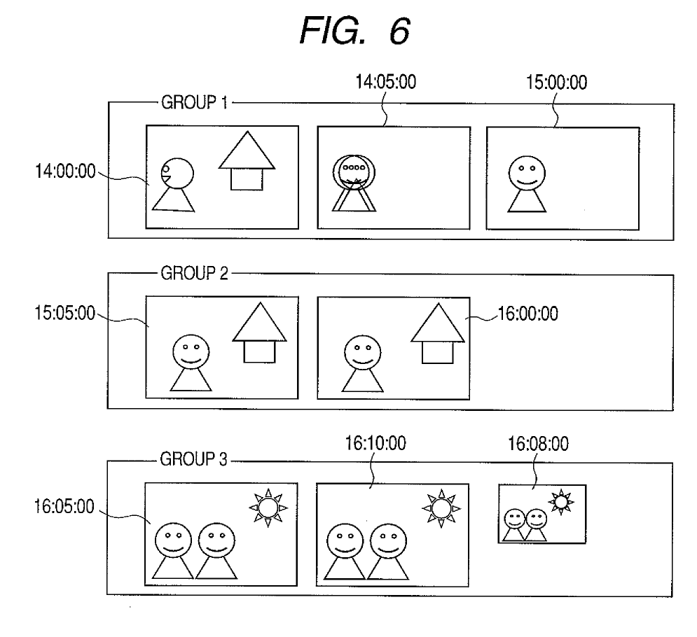

FIG. 6 shows an example of the videos, which are classified by the group classifying means upon the compositions thereof. In a group 1, a person appears at the same position, but directing a face aside, generating a hand deflection, and facing to a front, respectively, in the videos, and they differ from one another, largely, in the recording time thereof.

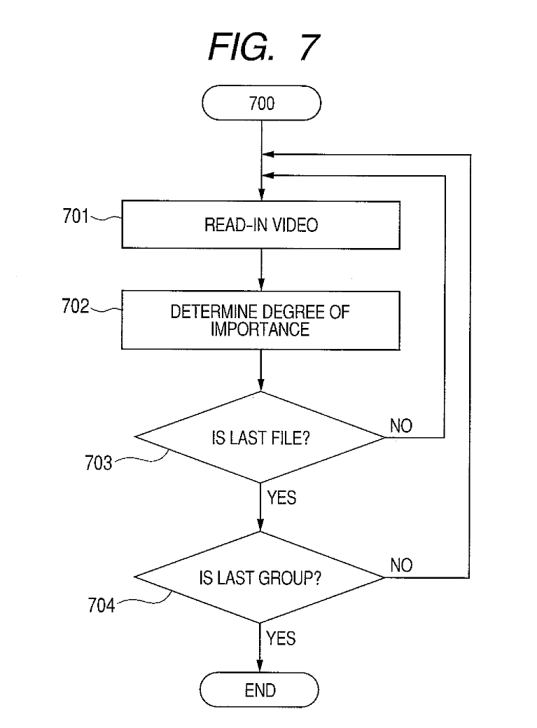

FIG. 7 shows a processing flow for determining a degree of importance, according to the present embodiment. In a step 701, read-in is made on one (1) piece of video belonging to the group 1 among the groups, which are classified in the step 300. In a step 702, the degree of importance is determined in accordance with items of importance. In a step 703, determination is made on whether it is the last video or not, within the group. If there is other video to be determined on the degree of importance, the process advances into the step 701. If it is the last video, then the process advances into a step 704. In the step 704 is determined on whether that group is the last group or not, on which the degree of importance should be determined. If there is other group to be determined on the degree of importance, then the process advances into the step 701, If it is the last group, then the process is ended.

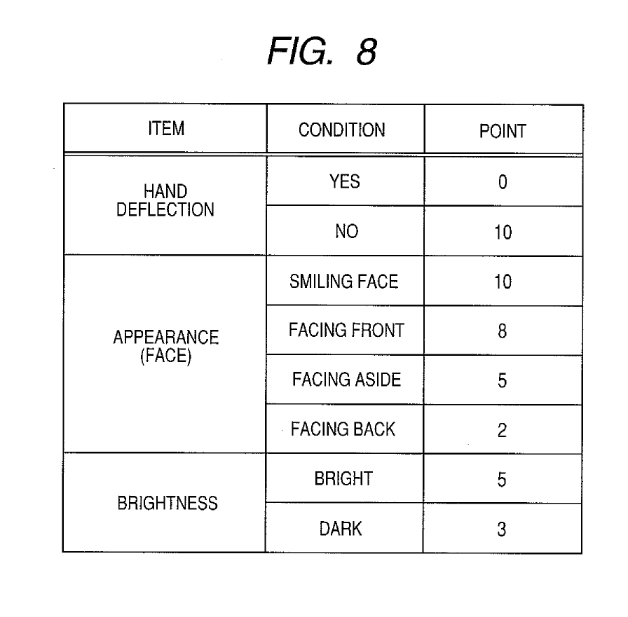

FIG. 8 shows items for determining the importance in the step 702. Among “items” shown in FIG. 8, points corresponding to “condition” fitting thereto are added. For example, when the hand deflection generates, the point is “0”, but “10” points are added when no hand deflection generates. Next, determination is made on an appearance or an angle of a face, and the points corresponding to that are added, in the following manner; e.g., “10” points when smiling, but “5” points when facing aside, for example.

Herein, which item should be considered to be important may be set up in advance by the equipment, or may be selected by the user, in the method thereof. Also, the point may be determined for “condition”, in advance, by the equipment, or may be selected by the user, in the method thereof.

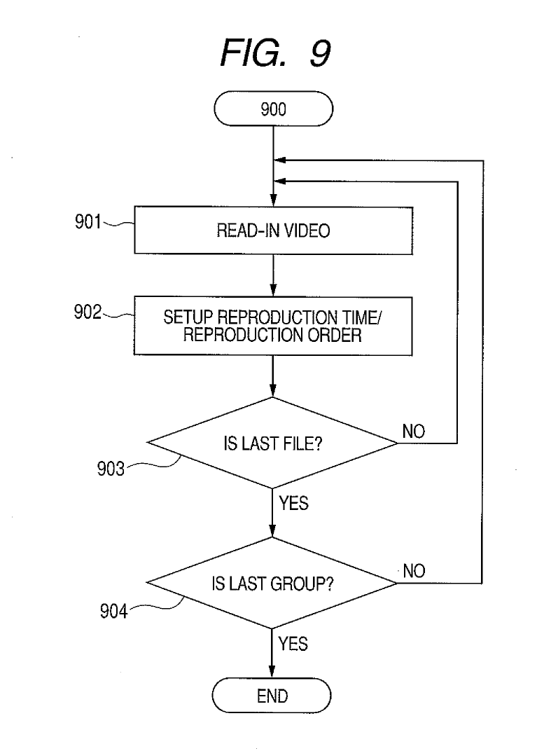

FIG. 9 shows a flow for determining the reproducing time/reproduction order, according to the present embodiment. In a step 901, read-in is made on one (1) piece of video belonging to one (1) group among the groups, which are classified in the step 300. In a step 902, a rank shown in FIG. 10 is determined upon basis of a rank, which is determined upon the points of importance determined in the step 700, and also the reproduction time upon basis of a correspondence table of reproduction times. When 1^{st} in rank, it is reproduced for 2.0 seconds. When 2^{nd}, for 1.0 second, when 3^{rd}, for 0.5 second, and when 4^{th} or below than that, since the reproduction time is 0 second, then no reproduction is made thereon. Also, the reproduction order is determined upon basis of a correspondence table between the rank and the order of reproduction shown in FIG. 11. In a step 903, determination is made on whether it is the last video or not within the group. When it is the last video, then the process advances into a step 904. In the step 904, determination is made on whether it is the last group or not, the degree of importance of which should be determined. If there is other group(s) to be determined on the degree of importance thereof, then the process advances to the step 901. When it is the last group, then the step is ended.

Also, the correspondence between the rank of degree of importance and the reproduction time, and the correspondence between the rank of degree of importance and the order of reproduction may be determined, in advance, by the equipment, or may be determined by the user, in the method thereof.

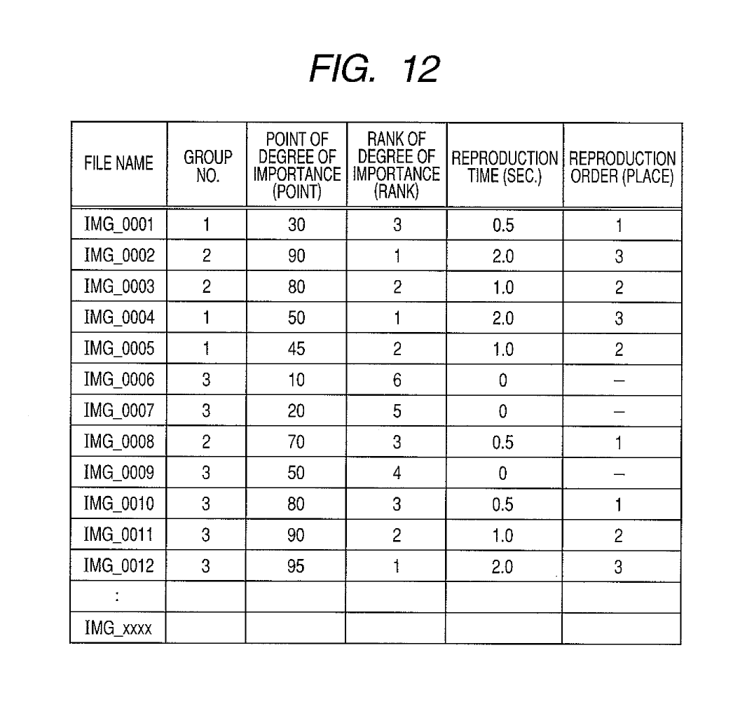

FIG. 12 shows video addition information. This is information relating to the reproduction time/reproduction order, etc., and is held within the internal memory, every time when it is determined in the step 300, the step 700 or the step 800. Regarding the rank of degree of importance and the reproduction order of the videos, they are the rank and the reproduction order within the group, to which they belong.

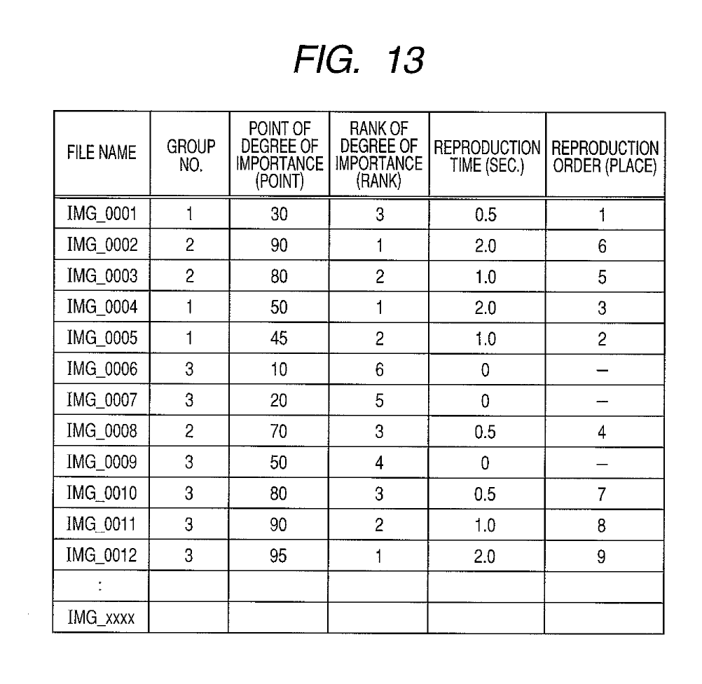

FIG. 13 shows the video addition information shown in FIG. 12, but being modified or revised. In this, the reproduction order within the group, among the information shown in FIG. 12, is modified into the reproduction order within all the videos.

The information to be written into the interior memory may be any one of those mentioned above.

When reproducing, reproduction is executed in the reproduction order and for the reproduction time, by referring to the video, in the reproduction order of the addition information shown in FIG. 12 or FIG. 13.

FIG. 14 shows an example of the present operation screen. As the video of an event 1, it is composed of plural numbers of videos, which are taken by “My Mobile Phone”, “My Digital Camera” and “Mr./Ms. A's Digital Camera”. The user selects the event 1, and further selects a button for starting “Slide Show” when wishing to view the video in a manner of the slide show. When trying to make the setup being settable by the user, such as, the method for determining the degree of importance, or the method for displaying the video, etc., for example, she/he may select a “Setup” button. When changing a line or order of the video (s) within each directory into the original time sequence thereof, she/he may select a “video Rearrange” button.

FIG. 15 shows an example of a screen for selecting a method of a video, which is low in the degree of importance, belonging to the same group. The user selects a method, such as, “Not Display”, or “Display as Background”, e.g., displaying the display time, which the user sets up to be displayed.

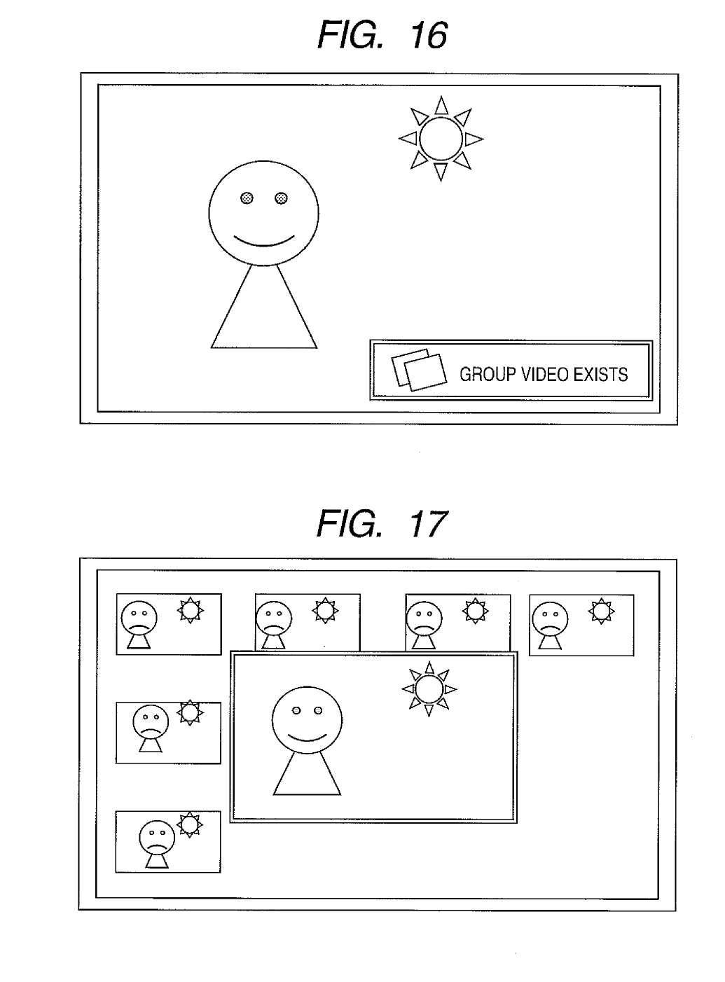

FIG. 16 shows an example of a slide shown reproduction screen. This is case of displaying the video, being high in the degree of importance, and there are other video (s) belonging to the same group. A display is made of indicating that there is/are other video (s) belonging to the group other than that. This may be achieved by displaying only information, or in the form of a button, which can be selected. With selection of a button, it is also possible to achieve a function, e.g., reproducing other video belonging to the same group.

FIG. 17 shows another example of the slide shown reproduction screen. This is case of displaying the video, being high in the degree of importance, and there are other video (s) belonging to the same group. Herein is shown the screen when selecting “display on a background” shown in FIG. 15. This displays the video, which is high in the degree of importance and is a target of the slide shown reproduction, largely, in a center thereof. At the same time, there are displayed other video (s) belonging to the same group, too. With doing this, it is possible for the user to confirm relating to the other video (s), while viewing the video that can be considered to be important for her/him. Relating to the other video (s), it/they may be only displayed; this may be achieve in the form of a button for enabling selection thereof. It is also possible to achieve a function of adding the target of the slide show, by selecting it with the button. Also, the position of the video disposing on the background should not be limited to the present example.

Description will be made about “Video Rearrange” process on the operation screen shown in FIG. 14.

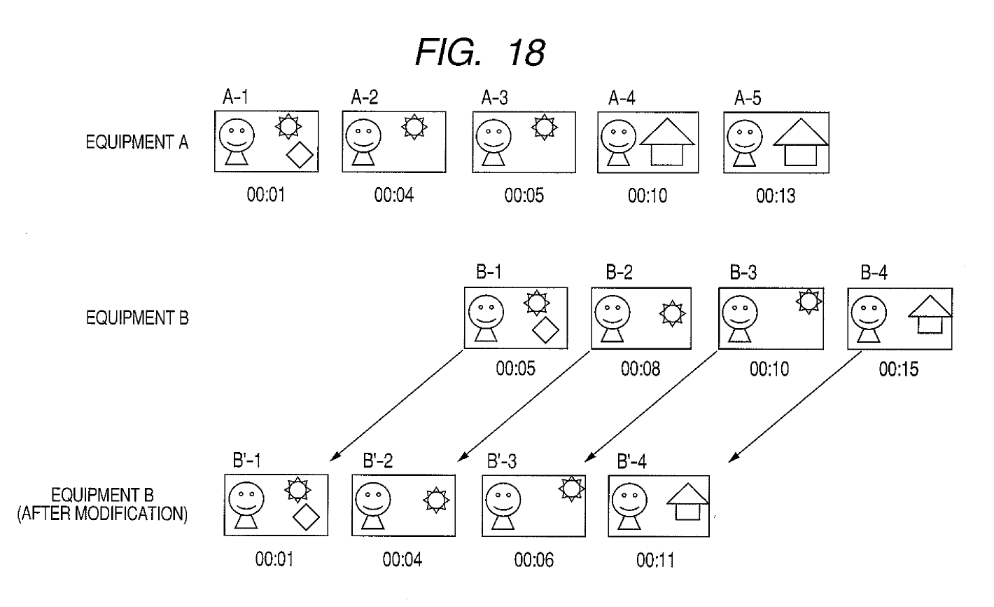

FIG. 18 shows the video recorded by the different image pickup equipment, when the recording time differs on a reference time. On the equipment “A”, videos A-1 to A-5 are recorded, sequentially. On the equipment “B”, videos B-1 to B-4 are recorded, sequentially. Herein, it is assumed that the videos A-1 and B-1 are recorded within the same time zone. However, since the time on each the equipment differs, the time information is different between the videos A-1 and B-1.

The characteristic quantities are calculated of the equipment A and the equipment B. The video is determined, which is highest in the degree of similarity, among the videos of the equipment A and the equipment B. It is assumed that the similarity is highest between the video A-1 and the video B-1, for example. Upon basis of the time information of the videos A-1 and B-1, the time information of other video(s) is modified. Upon which one of the time information should be based, between the equipment A and the equipment B, may be determined to be the video group, which is reserved in the reproducing apparatus at first or may be a video group having the largest number of pieces of the videos therein, or may be determined by the user.

Herein, mentioning will be made on case where the time information of the video group belonging to the equipment B is modified or revised. Judging from height of the similarity between the video A-1 and the video B-1, it is assumed that the both are taken at the same time, and the time difference is calculated between the video A-1 and the video B-1. The time information is modified or revises by adding or subtracting the time difference, which is calculated, to/from the time information of the video group belonging to the equipment B. Then, the video B-1 becomes the video B′-1, i.e., the time information is modified to the same time of the video A-1. The modification may be made on the other video B-2, etc., in the similar manner to the above-mentioned. With doing this, it is possible to arrange the video group, which is photographed by the equipment B, on a time axis same to that of the equipment A; i.e., it is possible to view the videos, which are photographed by the equipment A and the equipment B in the correct order when reproducing them in the order of the recording times thereof.

In the above, although the explanation was given on the preferred embodiments according to the present invention, by referring to the drawings attached herewith; however it is needless to say that the present invention should not be restricted to such the embodiments. For the person skilled in the art, it is apparent that various modifications or variations are conceivable within the scope of the technical ideas described in the pending claims, and it is also understood that those are of course within the technical region of the present invention.

The embodiments mentioned above are explained for the purpose of easy understanding of the present invention, for example, but the present invention should not be limited, necessarily, to that comprising all the elements or components explained on the above. Also, a part of a certain constituent element may be substituted with the constituent element of other embodiment, or the constituent element of other embodiment may be added to the constituent elements of a certain embodiment.

With using the present invention, it is possible to improve the convenience for the user by reproducing the video (s) that can be considered to be important for the user among a large amount of videos.

The explanation was given along the embodiments according to the present invention; however the present invention should not be limited to those embodiments. For example, the present invention is applicable into, not only the image pickup apparatus, such as, the digital camera, the video camera and the mobile phone equipped with the cameral, etc., but also into the equipment enable to reproduce and/or display the video, such as, a TV, a PV, or a digital photo-frame, etc.

What is claimed is:

1. A video reproducing apparatus for reproducing video data, comprising:
a group classify unit, which is configured to classify the video data into groups upon a degree of similarity of video characteristic;
an importance degree determine unit, which is configured to determine on whether a video belonging to the group is the video or not, being high in a degree of importance, among those within the group, which are classified by the group classifying unit;
a reproduction time setup unit, which is configured to set up reproduction time of video for each video, depending on the degree of importance, which is determined by said importance degree determine unit;
a unit, which is configured to hold the degree of importance and the reproduction time that are set up;
a video output unit, which is configured to output the video to a video display unit so that it is displayed in accordance with the reproduction time that is set up.

2. The video reproducing apparatus, as described in the claim 1, wherein
said group classify units are provided in a plural number thereof, and further comprising:
a selector unit, which is configured to enable a user to select one or more of said group classify units, among said plural number of group classify units.

3. The video reproducing apparatus, as described in the claim 1, further comprising:
a unit, which is configured to select said unit for a user to determine the degree of importance.

4. The video reproducing apparatus, as described in the claim 1, wherein
said video output unit outputs video reproduced and an indication that it belongs to a group that is classified by said importance degree determine unit, so that they are displayed, simultaneously.

5. The video reproducing apparatus, as described in the claim 1, wherein
said video output unit displays video reproduced and other video belonging to a group that is classified by said importance degree determine unit, so that they are displayed on a same screen.

6. The video reproducing apparatus, as described in the claim 1, further comprising:
a modify unit, which is configured to modify recoding time information of video belonging to a group that is classified by said group classify unit.

7. A video reproducing apparatus for reproducing video data, comprising:
a group classify unit, which is configured to classify the video data into groups upon a degree of similarity of video characteristic;
an importance degree determine unit, which is configured to determine on whether a video belonging to the group is the video or not, being high in a degree of importance, among those within the group, which are classified by the group classifying unit;
a reproduction order setup unit, which is configured to set up reproduction order of video for each video, by means of said importance degree determine unit and depending on the video a characteristic quantity;
a unit, which is configured to hold the degree of importance and the reproduction order that are set up;
a video output unit, which is configured to output the video to a video display unit so that it is displayed in accordance with the reproduction order that is set up.

8. The video reproducing apparatus, as described in the claim 7, wherein
said group classify units are provided in a plural number thereof, and further comprising:
a selector unit, which is configured to enable a user to select one or more of said group classify units, among said plural number of group classify units.

9. The video reproducing apparatus, as described in the claim 7, further comprising:
a unit, which is configured to select said unit for a user to determine the degree of importance.

10. The video reproducing apparatus, as described in the claim 7, wherein
said video output unit outputs video reproduced and an indication that it belongs to a group that is classified by said importance degree determine unit, so that they are displayed, simultaneously.

11. The video reproducing apparatus, as described in the claim 7, wherein
said video output unit displays video reproduced and other video belonging to a group that is classified by said importance degree determine unit, so that they are displayed on a same screen.

12. The video reproducing apparatus, as described in the claim 7, further comprising:
a modify unit, which is configured to modify recoding time information of video belonging to a group that is classified by said group classify unit.

13. A video reproducing apparatus, comprising:
a group classify unit, which is configured to classify the video data into groups upon a degree of similarity of video characteristic;
a determine unit, which is configured to determine a specific video from among videos belonging to a group, in accordance with a predetermined condition, within the groups that are classified by said group classify unit;
a video output unit, which is configured to output video data to a video display unit, so that it is displayed thereon;
a controller unit, which is configured to control said video output unit to output videos so that said specific video is reproduced differing from other video on reproduction time thereof, when reproducing video included in said group.

14. The video reproducing apparatus, as described in the claim 13, wherein
said predetermined condition is a condition that is predetermined or determined by a user, including at least one (1) or more of a hand deflection included in the video, a face direction that is recognized through a face recognition, and a brightness of video.
